(19) United States
(12) Patent Application Publication
(10) Pub. No.: US 2006/0262690 A1
(43) Pub. Date: Nov. 23, 2006

(54) System and method of compensating the tangential tilt in an optical data carrier signal

(76) Inventor: Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,975

(22) PCT Filed: May 12, 2004
(86) PCT No.: PCT/IB04/01609

§ 371 Date: Nov. 17, 2005

(30) Foreign Application Priority Data
May 20, 2003 (EP) 03291192.7

(51) Int. Cl. G11B 7/00

(52) U.S. Cl. 369/53.19

(57) ABSTRACT

The invention relates to a system and method of compensating the tangential tilt of an optical data carrier intended to store a primary data signal, said method comprising:—an adaptive tangential tilt compensation step (TTC) applied to a readout data signal (RDS) derived from said primary data signal, for generating a tilt-compensated data signal (TCDS) from a measure (MTT) of said tangential tilt,—a sampling rate conversion step (SRC-PLL) for converting the sampling rate of said tilt-compensated data signal (TCDS), so as to generate a sampling rate converted data signal (SRCDS),—a bit detection step (D)ET) applied to said sampling rate converted data signal (SRCDS) for generating an output data signal (ODS),—a tangential tilt estimation step (TTE) for generating said measure (MTT) of said tangential tilt. Use: tangential tilt compensation.

### FIELD OF THE INVENTION

The invention relates to a method of compensating the effect of the tangential tilt of an optical data carrier.

The present invention is applicable in the field of optical or magneto-optical disc systems.

### BACKGROUND OF THE INVENTION

Disc drive systems are designed for storing information onto a disc-shaped storage medium or reading information from such a disc-shaped storage medium. In such systems, the disc is rotated and a write/read head is moved radially with respect to the rotating disc.

An optical storage disc comprises at least one track, either in the form of a continuous spiral or in the form of multiple concentric circles, of storage space where information may be stored. Optical discs may be of the read-only type, where information is recorded during manufacture, which data can only be read by a user. The optical storage disc may also be of a writable type, where information may be stored by a user.

For writing information in the storage space of the optical storage disc, or for reading information from the disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc are commonly known, it is not necessary here to describe this technology in more detail.

For rotating the optical disc, an optical disc drive typically comprises a motor, which drives a hub engaging a central portion of the optical disc. Usually, the motor is implemented as a spindle motor, and the motor-driven hub may be arranged directly on the spindle axle of the motor.

For optically scanning the rotating disc, an optical disc drive comprises a light beam generator device (typically a laser diode), an objective lens for focusing the light beam in a focal spot on the disc, and an optical detector for receiving the reflected light reflected from the disc and for generating an electrical detector output signal.

During operation, the light beam should remain focused on the disc. To this end, the objective lens is arranged so as to be axially displaceable, and the optical disc drive comprises focal actuator means for controlling the axial position of the objective lens. Furthermore, the focal spot should remain aligned with a track or should be capable of being positioned with respect to a new track. To this end, at least the objective lens is mounted so as to be radially displaceable, and the optical disc drive comprises radial actuator means for controlling the radial position of the objective lens.

More particularly, the optical disc drive comprises a sledge, which is displaceably guided with respect to a disc drive frame, which frame also carries the spindle motor for rotating the disc. The travel course of the sledge is arranged substantially radially with respect to the disc, and the sledge can be displaced over a range substantially corresponding to the range from an inner track radius to an outer track radius. Said radial actuator means comprise a controllable sledge drive, for instance comprising a linear motor, a stepper motor, or a worm gear motor.

The displacement of the sledge is intended for roughly positioning the optical lens. For fine-tuning the position of the optical lens, the optical disc drive comprises a lens platform which carries the objective lens and which is displaceably mounted with respect to said sledge. The displacement range of the platform with respect to the sledge is relatively small but the positioning accuracy of the platform with respect to the sledge is greater than the positioning accuracy of the sledge with respect to the frame.

In many disc drives, the orientation of the objective lens is fixed, i.e. its axis is directed parallel to the rotation axis of the disc. In some disc drives, the objective lens is pivotably mounted, such that its axis can enclose an angle with the rotation axis of the disc. Usually, this is implemented by making the platform pivotable with respect to the sledge.

It is a general desire to increase the storage capacity of a record medium. One way of fulfilling this desire is to increase the storage density. To this end, optical scanning systems have been developed wherein the objective lens has a relatively high numerical aperture (NA). One problem involved in such optical systems is the increased sensitivity to tilt of the optical disc. Tilt of the optical disc may be defined as a situation where the storage layer of the optical disc, at the location of the focal spot, is not exactly perpendicular to the optical axis. Tilt can be caused by the optical disc being tilted as a whole, but is usually caused by the optical disc being warped, and as a consequence the amount of tilt depends on the location on the disc.

As depicted in FIG. 1, the tilt may have a radial component and a tangential component. The radial component (radial tilt) is the component β of the deviation in a plane oriented transversely to the track to be read (i.e. along the radial direction R) and transversely to the data carrier, while the tangential component (tangential tilt) is defined as the component α of the deviation in a plane oriented parallel to the track (i.e. along the tangential direction T) to be read and transversely to the data carrier.

FIG. 2 illustrates the laser beam incident on an optical disc having no tilt and optical discs having a radial and a tangential tilt. If the disc is not tilted, the optical beam 206 remains focused on the track 201. If the disc has radial or tangential tilt, which leads to comatic aberration, the optical beam is no longer focused on the tracks 202 and 203 but has a tail 204 and 205 respectively.

As a consequence, it is necessary in an optical disk system which uses a short wavelength laser diode and a high numerical aperture objective lens, to detect and correct the disc tilt, because the resulting comatic aberration deteriorates the read and write performance, and the tilt margin becomes narrower.

The tangential tilt of an optical disc can be compensated by known optical/mechanical solutions, such as a method using a three-dimensional actuator for the tangential tilt compensation, from a tangential tilt signal delivered by a tilt sensor. The quality of the tilt compensation is directly linked to the accuracy of the tilt signal.

There is thus a need both for estimating accurately and for compensating efficiently the tangential tilt of an optical data carrier.

The patent application U.S. Pat. No. 6,525,332 discloses a method for estimating the tangential tilt of an optical data carrier.

This known method leads to limitations since specific mechanic and optical elements are required. The corresponding drive is thus of considerable size, easily damageable, and expensive.

A signal-processing-based solution for tangential tilt compensation is depicted in FIG. 3. This method comprises a filtering step using a filter 301 applied to a readout signal 302 derived from a data signal stored on an optical disc. The bit synchronous data samples of the readout signal are equalized by the filter 301, which allows to generate an output data signal 303 in which the effects of the optical disc tangential tilt are attenuated. The coefficients 304 of the filter used in the filtering step are determined by an adaptation step 305 based on a least mean-square (LMS) algorithm Coefficients are determined so as to minimize the quadratic error signal 306, said error signal being derived from a subtraction between an optimal output data signal 307 and the output data signal 303.

Although the LMS algorithm is widely used in many application areas because of its simplicity, it has several disadvantages.

First, such an algorithm has a startup problem because the reference signal 307 is of poor quality when the system is not optimally adapted yet. The adaptive system may then get stuck at a totally wrong solution if initial coefficient settings are too far off from the correct one.

Secondly, such an algorithm may be quite slow in converging of the filter coefficients to its optimal value especially if the filter has a large number of coefficients. The effects of the tilt are thus not completely compensated in the output data signal.

Finally, the filter coefficients tend to become ill-defined, and their convergence properties degrade if the system has more coefficients than strictly needed, especially if the readout data signal is not spectrally rich, i.e. if the readout signals do not have frequential components in the overall frequential spectrum.

### OBJECT AND SUMMARY OF THE INVENTION

It is an object of the invention to propose a new class of schemes for tangential tilt compensation for optical storage systems.

A first family of methods according to the invention of compensating the tangential tilt of an optical data carrier intended to store a primary data signal comprises:
an adaptive tangential tilt compensation step (TTC) applied to a readout data signal (RDS) derived from said primary data signal, for generating a tilt-compensated data signal (TCDS) from a measure (MTT) of said tangential tilt,
a sampling rate conversion step (SRC-PLL) for converting the sampling rate of said tilt-compensated data signal (TCDS), so as to generate a sampling rate converted data signal (SRCDS),
a bit detection step (DET) applied to said sampling rate converted data signal (SRCDS) for generating an output data signal (ODS),
a tangential tilt estimation step (TTE) for generating said measure (MTT) of said tangential tilt.

A second family of methods according to the invention of compensating the tangential tilt of an optical data carrier intended to store a primary data signal comprises:
a sampling rate conversion step (SRC-PLL) for converting the sampling rate of a readout data signal (RDS) derived from said primary data signal, for generating a sampling rate converted data signal (SRCDS),
an adaptive tangential tilt compensation step (TTC) applied to said sampling rate converted data signal (SRCDS), so as to generate a tilt-compensated data signal (TCDS) from a measure (MTT) of said tangential tilt,
a bit detection step (DET) applied to said tilt-compensated data signal (TCDS) for generating an output data signal (ODS),
a tangential tilt estimation step (TTE) for generating said measure (MTT) of said tangential tilt.

The proposed methods are signal-processing-based only solutions for estimating and compensating the readout channel distortions caused by the tangential tilt. The tangential tilt of the optical data carrier may be estimated by the TTE step either bit-synchronously or bit-asynchronously.

These methods are more robust than the general-purpose signal processing schemes based on the LMS-type adaptive equalizer and lead to better results.

These methods allow to estimate and compensate tilt-related distortions even in the cases where the bit detection circuit produces bit decisions of poor quality, for example because of the large initial disc tilt that may happen during start-up. The proposed methods may also be combined with LMS-type equalizers, if needed.

Signal processing TTC and TTE circuits may be implemented in either bit-synchronous or bit-asynchronous clock domain.

The invention also relates to a computer program comprising code instructions for implementing the steps of the methods according to the invention.

The invention also relates to an optical disc drive that comprises processing means for implementing the steps of the methods according to the invention.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 illustrates a radial tilt and a tangential tilt in a optical data carrier,

FIG. 2 illustrates the comatic aberration of an optical spot on an optical data carrier,

FIG. 3 depicts a known method of tangential tilt compensation,

FIG. 4 depicts a first method according to the invention of tangential tilt compensation,

FIG. 5 depicts a second method according to the invention of tangential tilt compensation,

FIG. 6 depicts a third method according to the invention of tangential tilt compensation,

FIG. 7 depicts a fourth method according to the invention of tangential tilt compensation,

FIG. 8 depicts a fifth method according to the invention of tangential tilt compensation,

FIG. 9 depicts a sixth method according to the invention of tangential tilt compensation,

FIG. 10 depicts a seventh method according to the invention of tangential tilt compensation,

FIG. 11 depicts the different processing steps performed in a sampling rate data converter comprising a PLL.

### DETAILED DESCRIPTION OF THE INVENTION

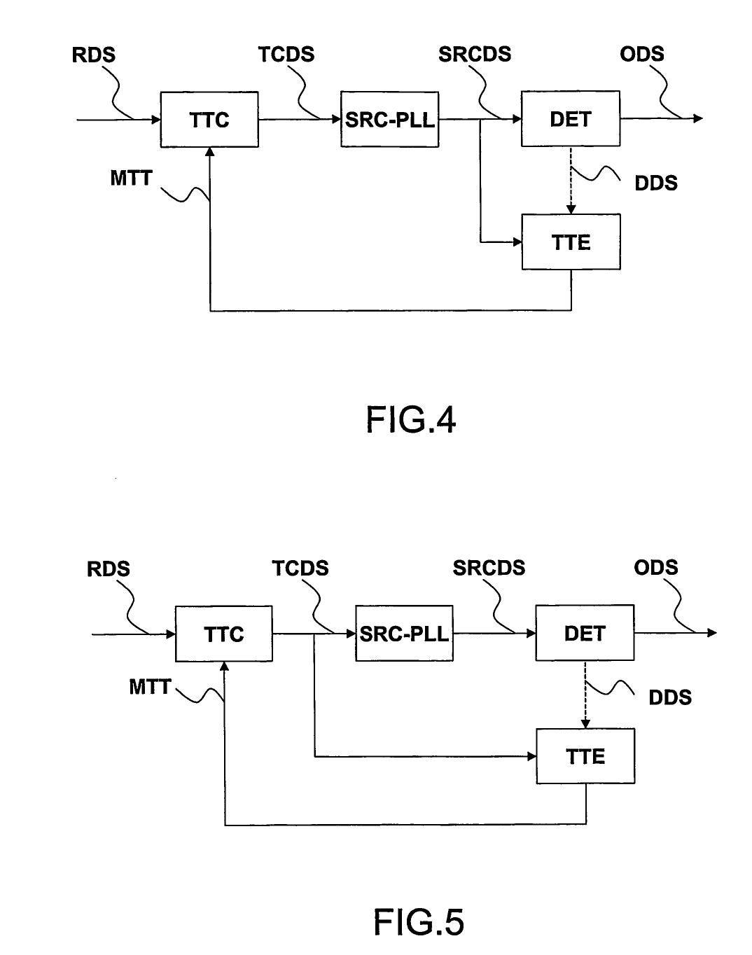

In the present invention, a number of different schemes (depicted in FIG. 4 to FIG. 10) for tangential tilt estimation and compensation are considered, in which tilt estimation and tilt compensation tasks are clearly separated from each other.

Such schemes are subdivided into a first and a second family of methods, said methods differing by the assembling of the different processing steps.

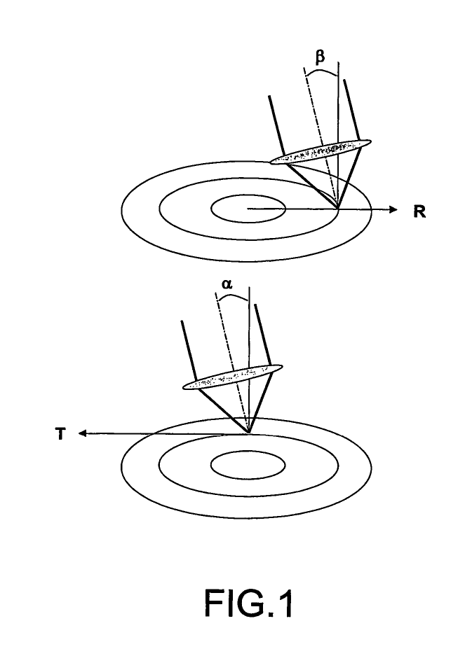

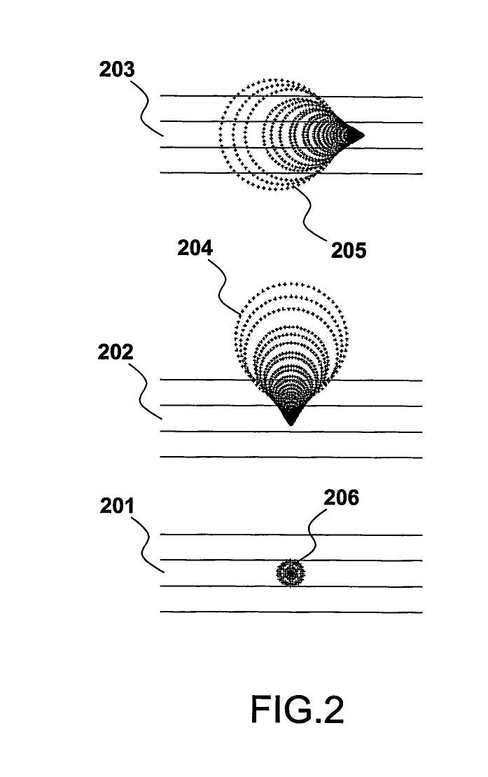

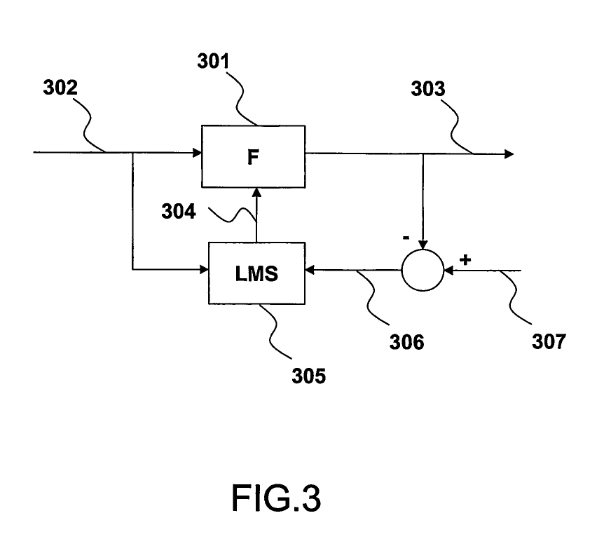

Each method uses a sampling rate conversion step (SRC-PLL), also called timing recovery step, aiming at re-sampling (i.e. interpolating) the incoming bit-asynchronous stream of readout samples into a stream of samples synchronized with the data bits stored on the optical data carrier. The re-sampling is performed from an internal clock derived, for example, from the incoming bit-asynchronous stream itself by means of a PLL (Phase Locked Loop). To this end, the SRC-PLL step comprises the set of processing steps depicted in FIG. 1. The sampling rate of the incoming bit-asynchronous stream IS is converted by a re-sampling step SRC from the internal clock IC generated by the discrete-time oscillator step (DTO). After rate conversion, the signal is successively fed through a noise filter and an equalizer EQ designed for filtering the incoming noise-filtered data signal in view of shaping the readout channel response and shaping the noise component in order to match both of them better to the requirements of the bit detector (DET), for generating the output re-sampled signal OS. The PLL comprises in series a phase detection step for detecting the phase of the output re-sampled signal OS, a loop filtering step for ensuring the stability of the loop, and said discrete-time oscillator step (DTO).

Each method uses a bit detection step (DET) for generating bit decisions, for example in forcing the incoming stream to 0 or 1 according to thresholds in the case of two-level signals, or in using maximum-likelihood sequence detection if a Viterbi-type bit detector is used. The DET step is designed to match the nominal transmission channel, i.e. a data channel in which the effects of tangential tilt are compensated.

Each method uses a tangential tilt estimation step (TTE) for producing an estimated measure of the tangential disc tilt, i.e. of the disc on which the primary data signal to be retrieved and read is stored.

Each method uses a tangential tilt compensation step (TTC) for adaptively compensating the effect of the tangential tilt from a measure of said tangential tilt generated by the TTE step.

The TTC filtering step uses a filter, which may be either of the FIR (Finite Impulse Response) or the IIR (Infinite Impulse response) type, or deriving from a combination of FIR and IIR types. The filter coefficients are precomputed for different values of the disc tilt and are updated during the drive operation based on the output of the tilt estimation circuit.

If the topology of the receiver is such that the TTC is always running at a clock, which is close to the bit clock of the data stored on the optical disc, then the filter coefficients are to be parameterized as a function of the tangential tilt a. Simple look-up tables, possibly combined with interpolation techniques, may be used for this purpose. For all values of the tangential tilt, the filter coefficients should be chosen such that the combination of the actual distorted channel and the filter approaches the nominal channel as good as possible.

The kernel of an adaptive linear-phase FIR filter may be defined as follows:
FIR_filter=[−k(α) 0 0 0 0 1 0 0 0 0 −k(α)] Eq. 1

This filter allows to suppress the tangential tilt a related amplitude distortion, the number of zeros depending on the optical spot resolution and the ratio between the bit frequency and the frequency at which the FIR filter is running. The coefficients k(α) of the filter may derive from a look-up table establishing a link between α and k(α), the look-up table being composed, for example, on the basis of experiments using known primary data signals to be retrieved from the optical disc.

For compensation of the phase distortions in the readout data signal, an all-pass IIR filter with a small number of zeros/poles can be used. For example, a tilt-dependent all-pass IIR filter with 3 second-order sections is sufficient for compensating the effect of tangential tilt in the range up to 1.5 degrees for the DVD+RW (Digital Versatile Disc+ReWritable) system. Another option is to use a tilt-dependent (adjustable) FIR filter for compensation of the phase distortions, this filter being combined with the FIR filter mentioned above for compensation of the amplitude distortions.

Any tangential tilt estimation step (TTE) may be used. However, signal-processing-based solutions are preferred.

Such a tangential tilt estimation TTE may be based on the fact that a side lobe appears on one side of the time-domain channel response of the readout channel when the tangential tilt is present, said readout channel being taken from among signals RDS, SRCDS or TCDS. The greater the value of tilt, the more pronounced the side lobe becomes.

Since the side lobe is also visible in the partial derivative g[k] of the time-domain channel response of the readout channel, k being an integer indicating the rank of the data samples, the side lobe of said partial derivative g[k] is modelled by a filter c[k] defined by a set of coefficients.

The tangential tilt value a may thus be derived from the following equivalent relations:
α={z[k]}corr{c[k]conv DDS[k]} Eq. 2
α={c[−k]conv z[k]}corr{DDS[k]} Eq. 3

where conv denotes the convolution operation,
corr denotes the correlation operation,
DDS[k] denotes a decision data signal corresponding to the primary data signal.

The above two relations are equivalent since the order of convolution and correlation operations can be reversed because of their linearity.

In a preferred version of the TTE step, and for taking into account the effect of asymmetry in the write channel, the method of tangential tilt estimation uses a decision data signal DDS[k] corresponding to the primary data signal. Decision data signal DDS is shown in dashed lines in FIG. 4 to FIG. 10.

Decision data signal DDS[k] may denote binary bit decisions from the alphabet a[k]={−1, +1}. The decision data signal a[k] is, for example, generated by the bit detector of the read channel usually located at the output of reading optical system.

Alternatively, DDS[k] may denote ternary bit decisions from the alphabet b[k]={1, B, +1}, where B is a coefficient derived from a[k] and on an estimate of the disc asymmetry.

The side lobe related part of the partial derivative g[k] of the channel response with respect to the tangential tilt angle is modelled, for example, by means of an anti-symmetrical FIR filter c[k] comprising two side lobes and formed by the following set of coefficients:
c[k]=[−A −B 0 0 0 . . . 0 0 0 +B +A]

where A and B are non-zero filter coefficients, and k the rank of coefficients.

A plurality of zeros are included in the central part of c[k] in order to achieve orthogonality with respect to the time-derivative of the readout channel response, for eliminating cross-talk with the timing recovery subsystem usually referred to as SRC-PLL and used in optical data reader for re-sampling the readout data signal. Coefficients of filter c[k] are thus chosen so as to define a filter kernel orthogonal to the time-derivative of the readout channel response.

Since the tangential tilt estimation is performed in looking at the presence (i.e. at the magnitude) of the component c[k] in the readout channel response, the sections [−A −B] and [+B +A] can be placed in the filter c[k] at the positions of the side lobes appear in the readout channel response, and chose coefficients A and B to be of the same sign. The simplest practical choice for the coefficients A and B is A=1 and B=1.

In the case of DVD+RW system, the sections [−A −B] and [+B +A] in the filter c[k] should be advantageously separated by 11 zeros assuming that the system works at the bit-synchronous clock, i.e. assuming the incoming bit-asynchronous readout data into the readout data signal are synchronized with the primary data bits stored on the optical data carrier.

The tilt estimation can also be applied in a different clock domain. To this end, the filter c[k] should be adjusted accordingly as a function of the over-sampling/under-sampling rate. The simplest solution is to adjust only the number of zeros in the middle of c[k], which works fine if the difference in clock speed is relatively small.

To facilitate the notation, the filter c[k] may be decomposed in two parts c1[k] and c2[k] such that:
c[k]=c1[k]conv c2[k] Eq. 4

The filters c1[k] and c2[k] are chosen such that the coefficients of the superposition filter c[k]={c1[k] conv c2[k]} model a number of anti-symmetric lobes arising in the channel response due to tangential tilt, and that the filter kernel of the superposition filter c[k]={c1[k] conv c2[k]} is orthogonal to the time-derivative of the channel response.

Then, considering the linearity of the convolution and correlation operators, instead of the 2 formulae Eq. 2 and Eq. 3, the following general formulae can be used:
α={c1[−k]conv z[k]}corr {c2[k]conv DDS[k]} Eq. 5

where c1=[1] and c2[k]=c[k] in Eq. 2,

where c1[k]=c[k] and c2=[1] in Eq. 3.

The method of estimating the tangential tilt thus comprises a cross-correlating step for correlating a first data signal m[k] defined by m[k]=c1[−k]conv z[k] derived from the readout signal z[k], with a second data signal w[k] defined by w[k]=c2[k]conv DDS[k] derived from a data decision signal DDS[k].

The first data signal m[k] may, for example, derive from:
a) A filtering step: In that case, m[k]=c1[−k]conv z[k], where c1[k]=1 if Eq. 2 applies.
b) A filtering step and an addition step of another signal q[k]. In that case, m[k]={c1[−k]conv z[k]}+q[k], where q[k] is any signal verifying q[k]corr w[k]=0 for the signal w[k] defined below. In particular, q[k]=0.
c) A non-linear operation like a clipping step. In that case, m[k]=sign({c1[−k]conv DDS[k ]}+q[k]).

The second data signal w[k] may, for example, derive from:
d) A filtering step: In that case, w[k]=c2[k] conv DDS[k], where c2[k]=1 if Eq. 3 applies.
e) A filtering step and an addition step of another signal p[k]. In that case, w[k]={c2[k]conv DDS[k]}+p[k], where p[k] is any signal verifying p[k]corr m[k]=0 for the signal m[k] defined above. In particular, p[k]=0.
f) A non-linear operation like a clipping step. In that case, w[k]=sign({c2[k] conv DDS[k]}+p[k]).

A first family of methods according to the invention of compensating the tangential tilt of an optical data carrier intended to store a primary data signal is depicted in FIG. 4 to FIG. 7. Each method of this first family comprises:
an adaptive tangential tilt compensation step (TTC) applied to a readout data signal (RDS) derived from said primary data signal, for generating a tilt-compensated data signal (TCDS) from a measure (MTT) of said tangential tilt,
a sampling rate conversion step (SRC-PLL) for converting the sampling rate of said tilt-compensated data signal (TCDS), so as to generating a sampling rate converted data signal (SRCDS),
a bit detection step (DET) applied to said sampling rate converted data signal (SRCDS) for generating an output data signal (ODS),
a tangential tilt estimation step (TTE) for generating said measure (MTT) of said tangential tilt.

In a first embodiment depicted in FIG. 4, the tangential tilt estimation step TTE is performed from said sampling rate converted data signal SRCDS.

The SRC-PLL step is placed after the TTC step so that it benefits from an incoming data signal TCDS in which the effects of tangential tilt have been compensated.

The TTE step is advantageously performed in the bit-synchronous domain, leading to an accurate estimated measure MTT of the tangential tilt.

The TTC step is advantageously performed in the bit-asynchronous clock domain, i.e. before re-sampling of the readout data signal, since the timing recovery step SRC-PLL benefits from a better quality of the tilt-compensated signal TCDS at its input.

In a second embodiment depicted in FIG. 5, the tangential tilt estimation step TTE is performed from said tilt-compensated data signal TCDS. The TTE step is performed in the bit-asynchronous domain. The TTC step is performed in the bit-asynchronous domain.

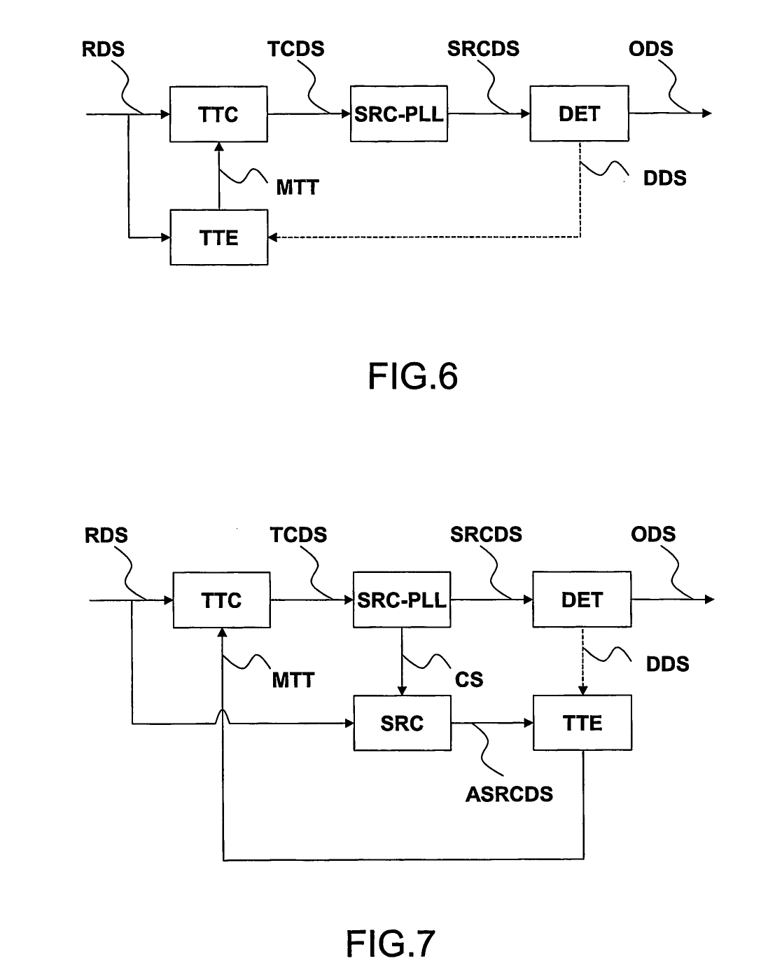

In a third embodiment depicted in FIG. 6, the tangential tilt estimation step TTE is performed from said readout data signal RDS. The TTE step is performed in the bit-asynchronous domain. The TTC step is performed in the bit-asynchronous domain.

In a fourth embodiment depicted in FIG. 7, the method further comprises an additional sampling rate conversion step SRC for converting the sampling rate of said readout data signal RDS, so as to generate an additional sampling rate converted data signal ASRCDS. The SRC step serves to interpolate the readout data signal RDS for matching its sampling frequency and phase with those of the SRCDS signal. The sampling moments of the SRC step are computed (or simply taken over) from the sampling moments derived in the SRC-PLL loop. The tangential tilt estimation step TTE is performed from said additional sampling rate converted data signal ASRCDS. The TTE step is performed in the bit-synchronous domain. The TTC step is performed in the bit-asynchronous domain.

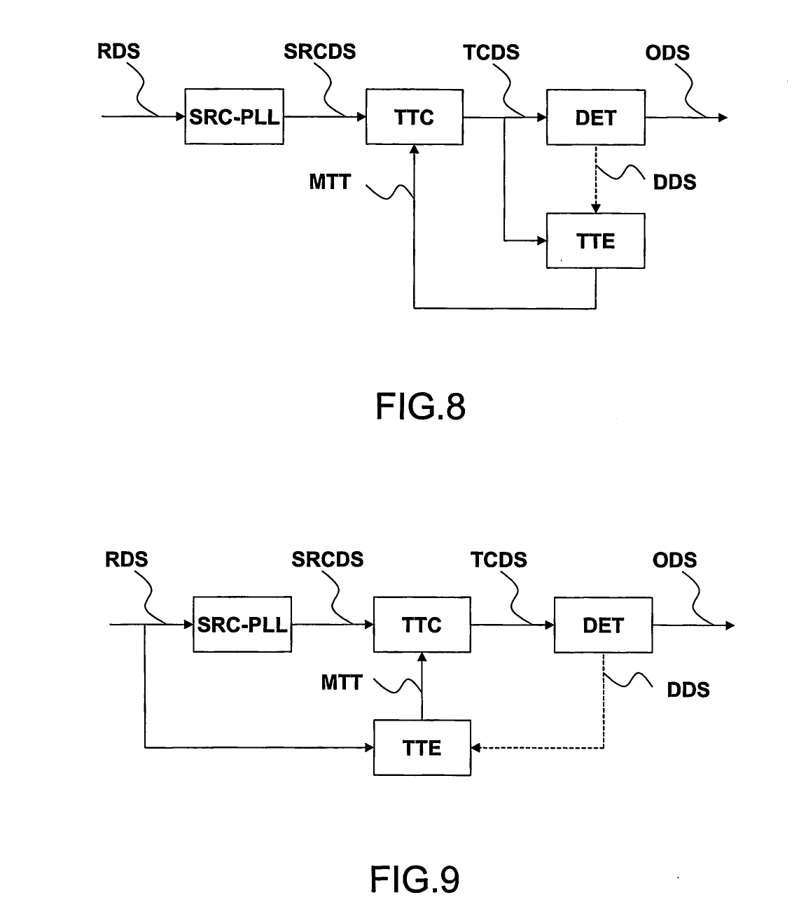

A second family of methods according to the invention of compensating the tangential tilt of an optical data carrier intended to store a primary data signal is depicted in FIG. 8 to FIG. 10. Each method of this second family comprises:
a sampling rate conversion step (SRC-PLL) for converting the sampling rate of a readout data signal (RDS) derived from said primary data signal, so as to generating a sampling rate converted data signal (SRCDS),
an adaptive tangential tilt compensation step (TTC) applied to said sampling rate converted data signal (SRCDS), for generating a tilt-compensated data signal (TCDS) from a measure (MTT) of said tangential tilt,
a bit detection step (DET) applied to said tilt-compensated data signal (TCDS) for generating an output data signal (ODS),
a tangential tilt estimation step (DIE) for generating said measure (MTT) of said tangential tilt.

In a fifth embodiment depicted in FIG. 8, the tangential tilt estimation step TTE is performed from said tilt-compensated data signal TCDS. The TTE step is performed in the bit-synchronous domain. The TTC step is performed in the bit-synchronous domain.

In a sixth embodiment depicted in FIG. 9, the tangential tilt estimation step TTE is performed from said readout data signal RDS. The TTE step is performed in the bit-asynchronous domain. The TTC step is performed in the bit-synchronous domain.

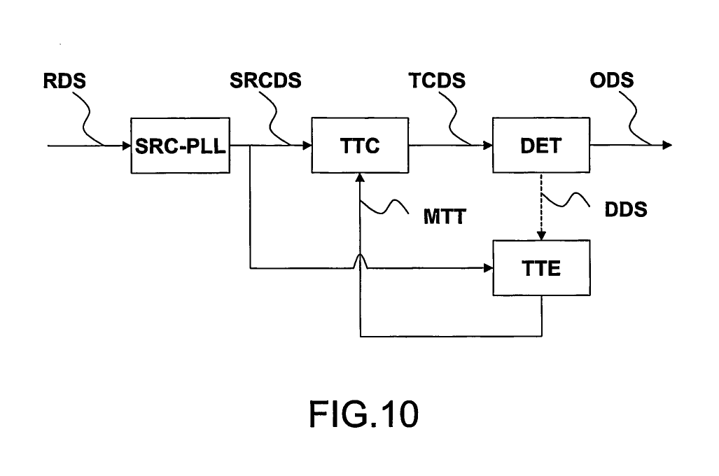

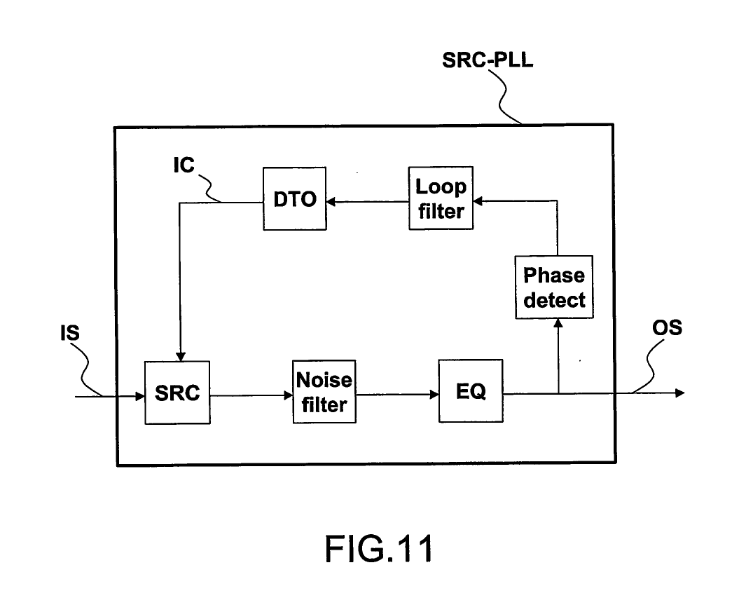

In a seventh embodiment depicted in FIG. 10, the tangential tilt estimation step TTE is performed from said sampling rate converted data signal SRCDS. The TTE step is performed in the bit-synchronous domain. The TTC step is performed in the bit-asynchronous domain.

If the TTC step is placed before the timing recovery circuit PLL as depicted in FIG. 4 and FIG. 5, then the derivative of the phase of the TTC filter characteristic (in the frequency domain) may be defined up to a constant, said constant being advantageously tilt-dependent. Indeed, such a phase delay is taken care of by the PLL of the SRC-PLL step.

If the TTC step is placed after the PLL as depicted in FIG. 8, then the derivative of the phase of the TTC filter characteristic should be matched to the output of the PLL and to the requirements at the input of the bit detection step DET.

In some optical data receivers, a wobble-driven clock in the quasi-synchronous domain is available before the SRC-PLL step. Either the asynchronous data may be sampled on the available quasi-synchronous clock, or another sampling rate converter step may be performed to ensure that the readout data signal RDS is sampled quasi-synchronously. In this case, the TTC step is running on an approximately known clock, and its coefficients need not be tabulated/adjusted as a function of a frequency mismatch between the bit clock and the TTC clock.

In some other optical data receivers, however, the quasi-synchronous clock is not available, and the TTC step should be able to work at clock frequencies different from the bit clock (i.e. the clock of the data stored on the optical data carrier). In this case, the ratio between the clock domains can be easily retrieved from the timing recovery subsystem SRC-PLL and used for adjusting the TTC circuit accordingly. The only condition in this case is that the adjustable filters in the asynchronous TTC should be parameterized as a function of the clock ratio and the tangential tilt.

The methods depicted in FIG. 4 to FIG. 10 are not limited to the compensation of the tangential tilt, but may also be applied to the compensation of other distortions. In particular, the TTE step may be replaced by a processing steps for estimating defocus or spherical aberrations in the optical channel.

The various methods according to the invention may be implemented by means of a computer program comprising code instructions for implementing the individual processing steps.

In an optical data carrier reader and/or writer, such methods may be implemented in an optical disc drive (e.g. as an electronic module or as an integrated circuit) for compensating the tangential tilt of an optical data carrier intended to store a primary data signal, said device comprising processing means, such as signal processors, executing code instructions of a computer program stored in a memory for implementing the steps of the methods according to the invention.

A first optical disc drive according to the invention comprises:
an adaptive tangential tilt compensation means (TTC) designed to receive a readout data signal (RDS) derived from said primary data signal, for generating a tilt-compensated data signal (TCDS) from a measure (MTT) of said tangential tilt,
sampling rate conversion means (SRC-PLL) for converting the sampling rate of said tilt-compensated data signal (TCDS), so as to generate a sampling rate converted data signal (SRCDS),
bit detection means (DET) applied to said sampling rate converted data signal (SRCDS) for generating an output data signal (ODS),
tangential tilt estimation means (TTE) for generating said measure (MTT) of said tangential tilt.

A second optical disc drive according to the invention comprises:
sampling rate conversion means (SRC-PLL) for converting the sampling rate of a readout data signal (RDS) derived from said primary data signal, so as to generate a sampling rate converted data signal (SRCDS),
adaptive tangential tilt compensation means (TTC) designed to receive said sampling rate converted data signal (SRCDS), for generating a tilt-compensated data signal (TCDS) from a measure (MTT) of said tangential tilt,
bit detection means (DET) designed to receive said tilt-compensated data signal (TCDS) for generating an output data signal (ODS),
tangential tilt estimation means (TTE) for generating said measure (MTT) of said tangential tilt.

The verb “comprise” does not exclude the presence of other elements than those listed in the claims.

1. Method of compensating the tangential tilt of an optical data carrier intended to store a primary data signal, said method comprising:
an adaptive tangential tilt compensation step (TTC) applied to a readout data signal (RDS) derived from said primary data signal, for generating a tilt-compensated data signal (TCDS) from a measure (MTT) of said tangential tilt,
a sampling rate conversion step (SRC-PLL) for converting the sampling rate of said tilt-compensated data signal (TCDS), so as to generate a sampling rate converted data signal (SRCDS),
a bit detection step (DET) applied to said sampling rate converted data signal (SRCDS) for generating an output data signal (ODS),
a tangential tilt estimation step (TTE) for generating said measure (MTT) of said tangential tilt.

2. Method as claimed in claim 1, wherein the tangential tilt estimation step (TTE) is performed from said sampling rate converted data signal (SRCDS).

3. Method as claimed in claim 1, wherein the tangential tilt estimation step (TTE) is performed from said tilt-compensated data signal (TCDS).

4. Method as claimed in claim 1, wherein the tangential tilt estimation step (TTE) is performed from said readout data signal (RDS).

5. Method as claimed in claim 1, further comprising an additional sampling rate conversion step (SRC) for converting the sampling rate of said readout data signal (RDS), so as to generate an additional sampling rate converted data signal (ASRCDS), said tangential tilt estimation step (TTE) being performed from said additional sampling rate converted data signal (ASRCDS).

6. Method as claimed in claim 2, wherein the tangential tilt estimation step (TTE) is also performed from a data decision signal (DDS) generated by said bit detection step (DET).

7. Method of compensating the tangential tilt of an optical data carrier intended to store a primary data signal, said method comprising:
a sampling rate conversion step (SRC-PLL) for converting the sampling rate of a readout data signal (RDS) derived from said primary data signal, for generating a sampling rate converted data signal (SRCDS),
an adaptive tangential tilt compensation step (TTC) applied to said sampling rate converted data signal (SRCDS), for generating a tilt-compensated data signal (TCDS) from a measure (MTT) of said tangential tilt,
a bit detection step (DET) applied to said tilt-compensated data signal (TCDS) for generating an output data signal (ODS),
a tangential tilt estimation step (TTE) for generating said measure (MTT) of said tangential tilt.

8. Method as claimed in claim 7, wherein the tangential tilt estimation step (TTE) is performed from said tilt-compensated data signal (TCDS).

9. Method as claimed in claim 7, wherein the tangential tilt estimation step (TTE) is performed from said readout data signal (RDS).

10. Method as claimed in claim 7, wherein the tangential tilt estimation step (TTE) is performed from said sampling rate converted data signal (SRCDS).

11. Method as claimed in claim 8, wherein the tangential tilt estimation step (TTE) is also performed from a data decision signal (DDS) generated by said bit detection step (DET).

12. A computer program comprising code instructions for implementing the steps of the method as claimed in claim 1.

13. Optical disc drive for compensating the tangential tilt of an optical data carrier intended to store a primary data signal, said optical disc drive comprising:
an adaptive tangential tilt compensation means (TTC) designed to receive a readout data signal (RDS) derived from said primary data signal, for generating a tilt-compensated data signal (TCDS) from a measure (MTT) of said tangential tilt,
sampling rate conversion means (SRC-PLL) for converting the sampling rate of said tilt-compensated data signal (TCDS), so as to generate a sampling rate converted data signal (SRCDS),
bit detection means (DET) applied to said sampling rate converted data signal (SRCDS) for generating an output data signal (ODS),
tangential tilt estimation means (TTE) for generating said measure (MTT) of said tangential tilt.

14. Optical disc drive for compensating the tangential tilt of an optical data carrier intended to store a primary data signal, said optical disc drive for comprising:
sampling rate conversion means (SRC-PLL) for converting the sampling rate of a readout data signal (RDS) derived from said primary data signal, for generating a sampling rate converted data signal (SRCDS),
adaptive tangential tilt compensation means (TTC) designed to receive said sampling rate converted data signal (SRCDS), for generating a tilt-compensated data signal (TCDS) from a measure (MTT) of said tangential tilt,
bit detection means (DET) designed to receive said tilt-compensated data signal (TCDS) for generating an output data signal (ODS),
tangential tilt estimation means (TTE) for generating said measure (MTT) of said tangential tilt.
